(19) United States
(12) Patent Application Publication
(10) Pub. No.: US 2026/0296185 A1
(43) Pub. Date: Oct. 1, 2026

(54) VEHICLE, POSITION ADJUSTMENT METHOD, AND STORAGE MEDIUM

(71) Applicant: HONDA MOTOR CO., LTD., Tokyo (JP)

(72) Inventor: Kenta Maruyama, Tokyo (JP)

(21) Appl. No.: 19/532,559

(22) Filed: Feb. 6, 2026

(30) Foreign Application Priority Data
Mar. 28, 2025 (JP) 2025-056379

(51) Int. Cl. B60K 35/10; G06V 20/56

(52) U.S. Cl. CPC B60K 35/10; G06V 20/56; B60R 2300/105

(57) ABSTRACT

A vehicle that uploads a captured image captured by a streamer terminal to a streaming server as a streaming image, the vehicle including: a touch panel; an external communication I/F that communicates with the streaming server; and a first control section that: acquires the captured image captured by the streamer terminal retained by an attachment; superimposes a guide image including guide lines for guiding a capturing position of the streamer terminal on the captured image, based on an image captured in the acquired captured image; and displays the captured image on which the guide image is superimposed on the touch panel.

### INCORPORATION BY REFERENCE

The present application claims priority under 35 U.S.C. § 119 to Japanese Patent Application No. 2025-056379 filed on Mar. 28, 2025. The content of the application is incorporated herein by reference in its entirety.

### BACKGROUND OF THE INVENTION

### Field of the Invention

The present invention relates to a vehicle, a position adjustment method, and a storage medium.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users.

The development of technologies for giving driving assistance to drivers is also actively being carried out. For example, Japanese Patent Laid-Open No. 2022-64677 discloses a technology for giving driving assistance by displaying opaque or semi-transparent lines such as guide lines, prediction lines, or target lines on an image from a rear camera of a vehicle and an overhead image obtained by combining imaging data from each camera of a camera system.

When capturing a state of an inside of the vehicle using a camera such as that of a smartphone and streaming a captured image as a streaming image, there is a problem that the camera needs to be placed taking into consideration angle of view and the like, which complicates placement of the camera in the vehicle. The present invention was made in view of the above-described circumstances and has an object to assist placement of a capturing apparatus in a vehicle and to enhance ease of placement. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

An aspect of the present disclosure is a vehicle that uploads a captured image captured by a capturing apparatus to a streaming server as a streaming image, the vehicle including: an in-vehicle display apparatus; a communication apparatus configured to communicate with the streaming server; and a control apparatus configured to: acquire the captured image captured by the capturing apparatus retained by an in-vehicle retainer; superimpose a guide image including guide lines for guiding a capturing position of the capturing apparatus on the captured image, based on an image captured in the acquired captured image; and display the captured image on which the guide image is superimposed on the in-vehicle display apparatus.

According to the present disclosure, it is possible to adjust the capturing position of the capturing apparatus while looking at the guide lines displayed on the in-vehicle display apparatus, which facilitates angle of view adjustment of the capturing apparatus, since the guide image including the guide lines for guiding the capturing position of the capturing apparatus is superimposed on the captured image based on the image captured by the capturing apparatus, and the captured image on which the guide image is superimposed is displayed on the in-vehicle display apparatus.

### BRIEF DESCRIPTION OF THE DRAWINGS

FIG. 1 is a diagram showing a system configuration of a streaming system;

FIG. 2 is a block diagram showing a configuration of an in-vehicle apparatus and a streaming server;

FIG. 3 is a diagram showing an attachment example of a streamer terminal in a vehicle;

FIG. 4 is a diagram showing an attachment example of the streamer terminal in the vehicle;

FIG. 5 is a diagram showing an example of a first guide image;

FIG. 6 is a diagram showing an example of a second guide image;

FIG. 7 is a diagram showing an example of a third guide image;

FIG. 8 is a diagram showing an example of a user registration database;

FIG. 9 is a diagram showing an example of a stream management database;

FIG. 10 is a block diagram showing a configuration of the streamer terminal and a viewer terminal;

FIG. 11 is a diagram showing an example of a composite image;

FIG. 12 is a diagram showing an example of the composite image; and

FIG. 13 is a flowchart showing an operation of an in-vehicle apparatus.

### DETAILED DESCRIPTION OF THE INVENTION

Hereinafter, an embodiment of the present invention will be described with reference to the drawings.

### Embodiment

### 1. Configuration of Streaming System

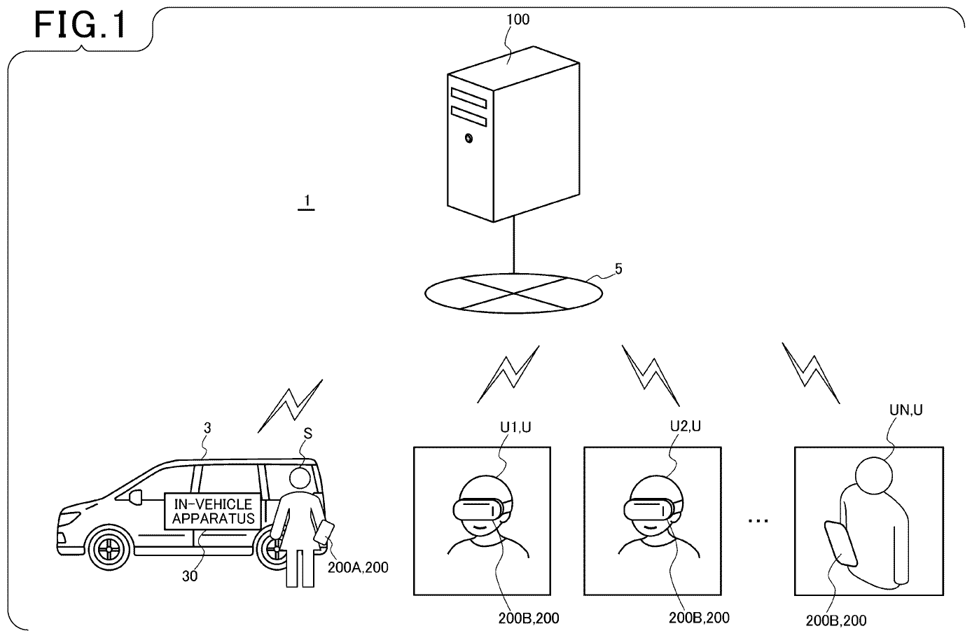

FIG. 1 is a diagram showing a system configuration of a streaming system 1.

The streaming system 1 includes an in-vehicle apparatus 30, a streamer terminal 200A, a streaming server 100, and a viewer terminal 200B. The streaming system 1 is a system for live streaming content including an image captured by the streamer terminal 200A.

Live streaming refers to an activity in which a streamer and an unspecified viewer participate, and an image based on a capturing result from the streamer terminal 200A is streamed in real-time to the viewer terminal 200B. The image may be a still image or a moving image.

The in-vehicle apparatus 30 is installed in a vehicle 3 and is wirelessly connected via short-range wireless communication or the like to the streamer terminal 200A possessed by a streamer S being a passenger of the vehicle 3.

The in-vehicle apparatus 30 receives, from the streamer terminal 200A, content data including an image captured by a camera included in the streamer terminal 200A and speech input via a microphone included in the streamer terminal 200A. The in-vehicle apparatus 30 uploads the received content data to the streaming server 100.

The streamer terminal 200A may be a smartphone or tablet personal computer (PC), or may be a camera such as a digital camera or a 360-degree camera capable of capturing an entire surrounding area. In this case, the microphone and the camera may be implemented separately. The streamer terminal 200A corresponds to a capturing apparatus.

The streaming server 100 stores the content data received from the in-vehicle apparatus 30 in a server storage unit. The streaming server 100 streams the uploaded content data to the viewer terminal 200B of a viewer U. Live streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a terminal apparatus possessed by the viewer U that views the content data streamed from the streaming server 100. FIG. 1 shows U1, U2, . . . , UN viewers U as the viewer U. N is an arbitrary natural number.

For example, the viewer terminal 200B may be a portable or mobile terminal apparatus such as a smartphone, tablet PC, or notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed.

Hereinafter, the streamer terminal 200A and the viewer terminal 200B will be notated as a terminal apparatus 200 when collectively referring thereto.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of In-Vehicle Apparatus

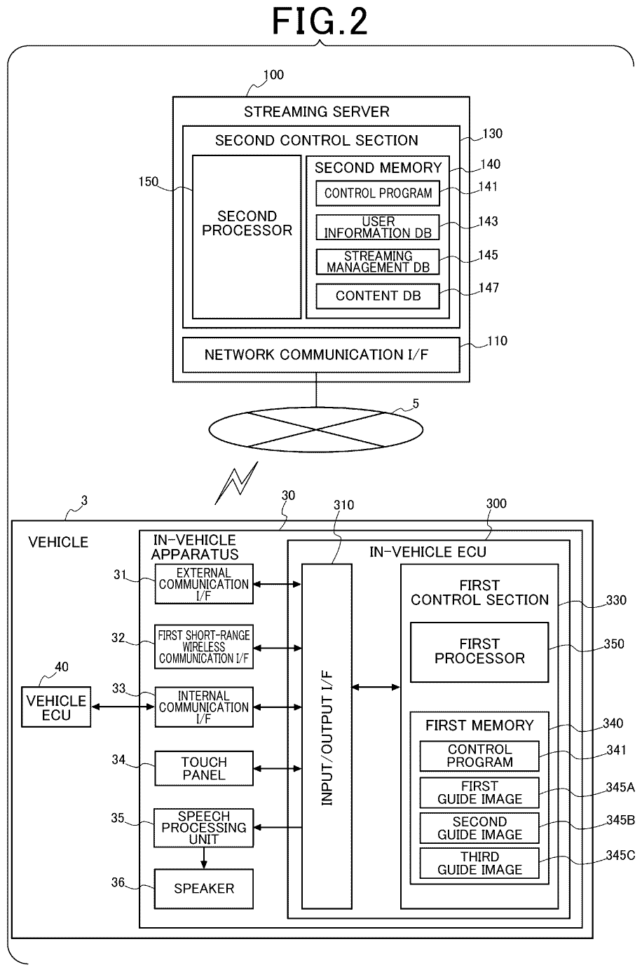

FIG. 2 is a diagram showing a configuration of the in-vehicle apparatus 30 and the streaming server 100.

First, the configuration of the in-vehicle apparatus 30 will be described with reference to FIG. 2.

The in-vehicle apparatus 30 includes an external communication interface 31, a first short-range wireless communication interface 32, an internal communication interface 33, a touch panel 34, a speech processing unit 35, a speaker 36, and an in-vehicle electronic control unit (ECU) 300. Hereinafter, interface will be abbreviated as I/F.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100. The external communication I/F 31 corresponds to a communication apparatus.

For example, the first short-range wireless communication I/F 32 is a communication module that performs communication in accordance with a near-field communication (NFC) standard such as Bluetooth (registered trademark) or Wi-Fi. The first short-range wireless communication I/F 32 performs short-range wireless communication with a terminal apparatus possessed by a passenger and receives an image captured by the terminal apparatus, speech, and the like.

The internal communication I/F 33 is an input/output interface connected to an in-vehicle network (not shown). For example, a communication bus supporting a communication standard such as controller area network (CAN), CAN with Flexible Data-Rate (CAN-FD), or Ethernet (registered trademark) is used for the in-vehicle network. The internal communication I/F 33 performs mutual data communication via the in-vehicle network with in-vehicle equipment such as a vehicle ECU 40 or another relay apparatus. For example, the vehicle ECU 40 is a control apparatus that controls traveling of the vehicle 3, and transmits a vehicle speed, transmission lever position information, and a drive state of a drive source such as an engine of the vehicle 3 to the in-vehicle ECU 300 via the in-vehicle network. The vehicle ECU 40 corresponds to a vehicle control apparatus.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330. The touch panel 34 corresponds to an in-vehicle display apparatus and a reception apparatus.

For example, the speech processing unit 35 includes a processor and converts digital speech data output by the first control section 330 into an analog speech signal. The speech processing unit 35 amplifies the converted analog speech signal and outputs the amplified speech signal via the speaker 36.

The in-vehicle ECU 300 includes an input/output I/F 310 and the first control section 330. The in-vehicle ECU 300 corresponds to a control apparatus.

The input/output I/F 310 functions as a connection unit between the first control section 330 and the external communication I/F 31, the first short-range wireless communication I/F 32, the internal communication I/F 33, the touch panel 34, and the speech processing unit 35. The input/output I/F 310 includes a connector and an interface circuit. The input/output I/F 310 outputs data input from the external communication I/F 31, the first short-range wireless communication I/F 32, the internal communication I/F 33, the touch panel 34, and the speech processing unit 35 to the first control section 330. The input/output I/F 310 outputs data input from the first control section 330 to the external communication I/F 31, the first short-range wireless communication I/F 32, the internal communication I/F 33, the touch panel 34, or the speech processing unit 35.

The first control section 330 is a computer apparatus including a first memory 340 and a first processor 350. The first processor 350 corresponds to a processor.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 341 executed by the first processor 350; a first guide image 345A, a second guide image 345B, and a third guide image 345C; and the like.

### 3. Placement Method of Streamer Terminal in Vehicle

Here, a placement method of the streamer terminal in the vehicle 3 will be described, and the first guide image 345A, the second guide image 345B, and the third guide image 345C stored in the first memory 340 will also be described.

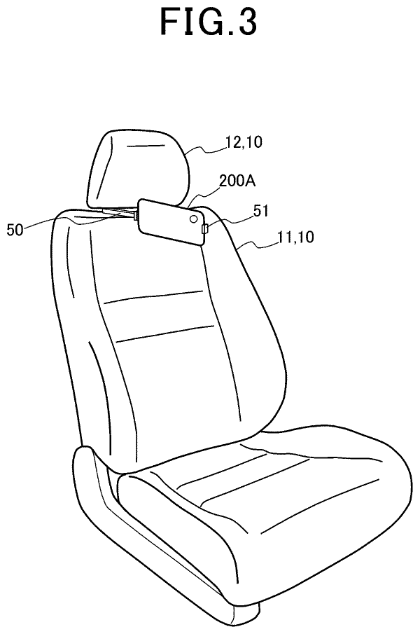

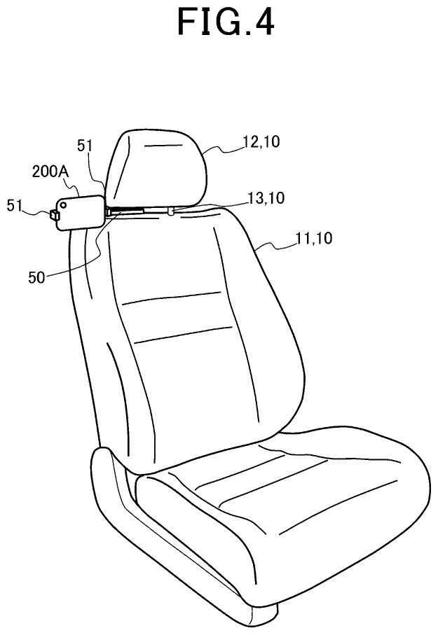

FIGS. 3 and 4 are diagrams showing attachment examples of the streamer terminal 200A in the vehicle 3.

FIGS. 3 and 4 show examples in which the streamer terminal 200A is attached to a passenger seat 10 of the vehicle 3.

The streamer terminal 200A is attached to the seat 10 via an attachment 50. The attachment 50 is attached to a headrest stay 13 that fixes a headrest 12 of the passenger seat 10 to a backrest 11. The attachment 50 corresponds to an in-vehicle retainer.

FIG. 3 shows an example in which the streamer terminal 200A is attached to the passenger seat 10 so that the streamer S seated in a driver seat is included in an angle of view of the streamer terminal 200A. An attachment position of this streamer terminal 200A is referred to as a first capturing position.

FIG. 4 shows an example in which the streamer terminal 200A is attached to the passenger seat 10 so that an area in front of the vehicle 3 is included in the angle of view of the streamer terminal 200A. The attachment position of this streamer terminal 200A is referred to as a second capturing position. The streamer terminal 200A can also be attached to the passenger seat 10 so that a back seat of the vehicle 3 is included in the angle of view of the streamer terminal 200A. An attachment position of this streamer terminal 200A is referred to as a third capturing position.

A first holder 51 for fixing the streamer terminal 200A to the attachment 50 is provided at one end portion of the attachment 50 and a second holder for fixing the attachment 50 to the headrest stay 13 is provided at the other end portion of the attachment 50. Illustration of the second holder is omitted. After changing an attachment direction of the attachment 50 to the headrest stay 13, the streamer terminal 200A is attached to the passenger seat 10 in the first capturing position, the second capturing position, or the third capturing position by fixing the attachment 50 to the headrest stay 13 via the second holder.

### 4. Attachment of Streamer Terminal in Vehicle

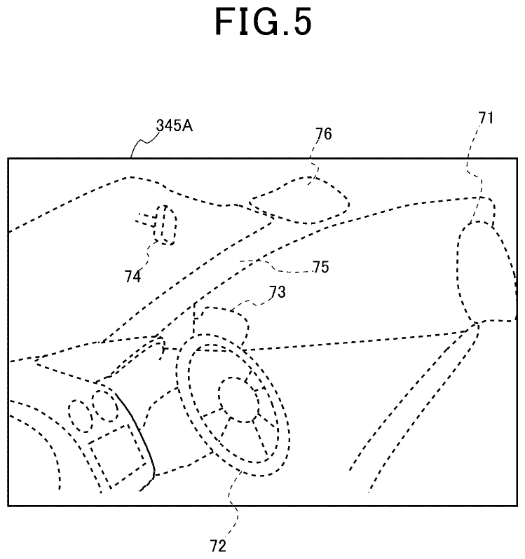

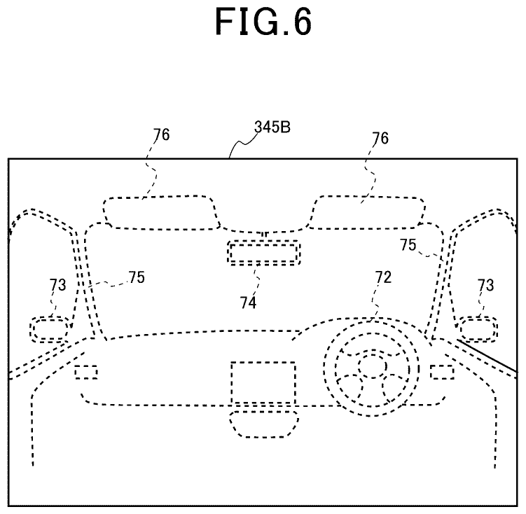

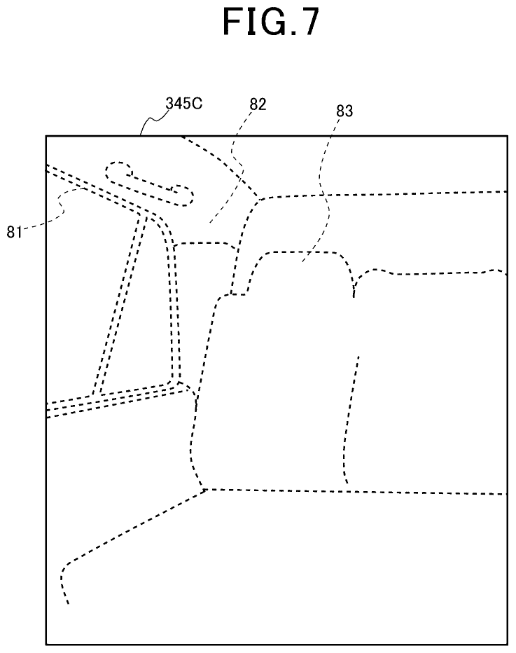

FIG. 5 is a diagram showing an example of the first guide image 345A, FIG. 6 is a diagram showing an example of the second guide image 345B, and FIG. 7 is a diagram showing an example of the third guide image 345C. Hereinafter, the first guide image 345A, the second guide image 345B, and the third guide image 345C will be notated as a guide image 345 when collectively referring thereto.

The first guide image 345A is a guide image to be combined with a captured image when the attachment position of the streamer terminal 200A is the first capturing position. The first guide image 345A corresponds to a guide image corresponding to the first capturing position. The first guide image 345A is, for example, generated using a captured image taken during a previous stream. The first control section 330 extracts a contour of an object captured in the captured image and generates the first guide image 345A that displays the extracted contour of the object as guide lines. The first guide image 345A includes, for example, a driver seat 71, a steering wheel 72, a side-view mirror 73 at a driver seat side, a rear-view mirror 74, an A-pillar 75, and a sun visor 76 at the driver seat side.

The second guide image 345B is a guide image to be combined with a captured image when the attachment position of the streamer terminal 200A is the second capturing position. The second guide image 345B corresponds to a guide image corresponding to the second capturing position. The second guide image 345B is, for example, generated using a captured image taken during a past stream. The second guide image 345B includes, for example, the steering wheel 72, the side-view mirror 73, the rear-view mirror 74, the A-pillar 75, and the sun visor 76.

The third guide image 345C is a guide image to be combined with a captured image when the attachment position of the streamer terminal 200A is the third capturing position. The third guide image 345C is, for example, generated using a captured image taken during a past stream. The third guide image 345C includes, for example, a window frame 81, a C-pillar 82, and a back seat 83.

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

### 5. Configuration of Streaming Server

Next, a configuration of the streaming server 100 will be described.

The streaming server 100 includes a network communication I/F 110 and a second control section 130.

For example, the network communication I/F 110 includes a communication card such as a network interface card (NIC), and performs mutual data communication via the communication network 5 with the in-vehicle apparatus 30, the streamer terminal 200A, and the viewer terminal 200B.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 includes an auxiliary storage apparatus such as a hard disk drive (HDD) or an SSD.

The second memory 140 stores a control program 141 executed by the second processor 150, a user information database 143, a stream management database 145, and a content database 147. Hereinafter, database will be abbreviated as DB.

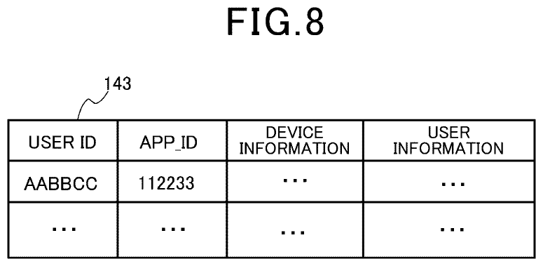

FIG. 8 is a diagram showing a configuration of the user information DB 143.

One record in the user information DB 143 includes a user ID, APP_ID, device information, and user information. APP is an abbreviation of application program.

The user ID is identification information for identifying a user utilizing a streaming service provided by the streaming server 100. The user includes the streamer S and the viewer U.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is identification information for identifying the terminal apparatus 200. The device information is, for example, information indicating whether the terminal apparatus 200 is a smartphone, a PC, a head-mounted display apparatus, or a camera. For example, a model number is used for the device information. The device information includes communication information such as an IP address.

The user information is personal information of the streamer S and the viewer U being the user. The user information includes, for example, information such as name, address, sex, and age.

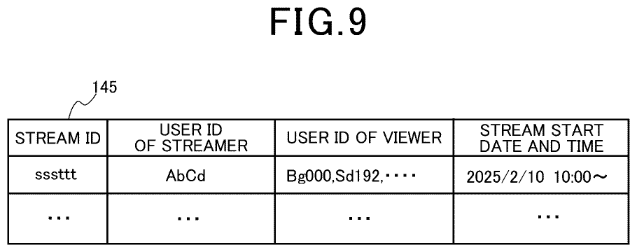

FIG. 9 is a diagram showing a configuration of the stream management DB 145.

One record in the stream management DB 145 includes a stream ID for identifying a stream, the user ID of the streamer S, the user ID of the viewer U, and a stream start date and time.

Returning to FIG. 2, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

### 6. Configuration of Terminal Apparatus

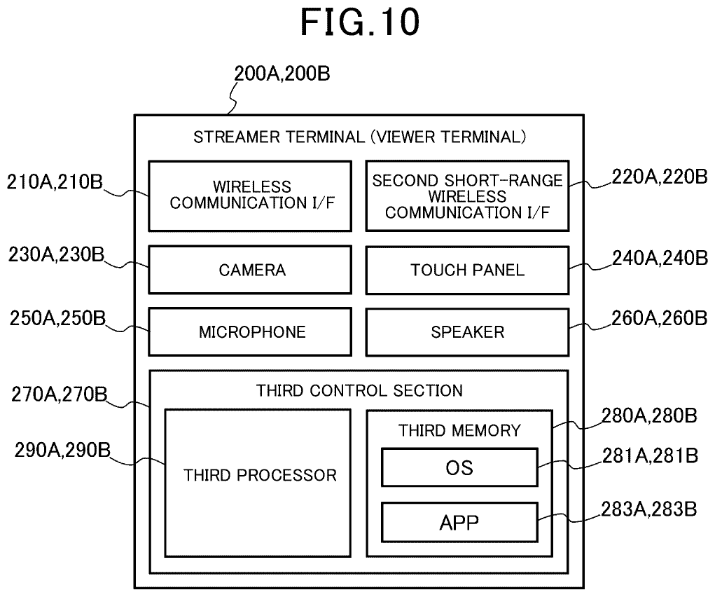

FIG. 10 is a block diagram showing a configuration of the streamer terminal 200A and the viewer terminal 200B. Since the configuration of the streamer terminal 200A and the viewer terminal 200B are substantially the same, description thereof will be based on the configuration of the streamer terminal 200A. In the following description, components of the streamer terminal 200A are denoted with reference sign “A” and components of the viewer terminal 200B are denoted with reference sign “B” for distinction. For example, a third control section 270 included in the streamer terminal 200A is notated as a “third control section 270A” and a third control section 270 included in the viewer terminal 200B is referred to as a “third control section 270B.”

The streamer terminal 200A includes a wireless communication I/F 210A, a second short-range wireless communication I/F 220A, a camera 230A, a touch panel 240A, a microphone 250A, a speaker 260A, and the third control section 270A.

The wireless communication I/F 210A is a communication module that performs wireless communication in accordance with a mobile communication standard such as LTE, 4G, 5G, or Wi-Fi. The wireless communication I/F 210A is connected to the communication network 5 via an antenna (not shown) and performs mutual data transmission/reception with the streaming server 100.

For example, the second short-range wireless communication I/F 220A is a communication module that performs communication in accordance with an NFC standard such as Bluetooth or Wi-Fi. The second short-range wireless communication I/F 220A transmits a captured image captured by the camera 230A, speech input via the microphone 250A, and the like to the in-vehicle apparatus 30 through short-range wireless communication with the in-vehicle apparatus 30.

The camera 230A is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor. The captured image generated by the camera 230A is transmitted to the in-vehicle apparatus 30 under the control of the third control section 270A.

The microphone 250A is a speech input apparatus for inputting speech of the streamer S, and the speaker 260A is a speech output apparatus for outputting speech of the streamer S, the viewer U and the like.

The touch panel 240A includes a display panel such as a liquid-crystal panel or an organic EL panel, and a touch sensor. The touch panel 240A functions as a display part for displaying an image and as a reception part for accepting an operation by the streamer S.

The third control section 270A is a computer apparatus including a third memory 280A and a third processor 290A.

The third memory 280A includes a non-volatile semiconductor memory. The third memory 280A may include an auxiliary storage apparatus such as an SD card. The third memory 280A stores control programs such as an operating system (OS) 281A and an APP 283A. The APP 283A is an application program that performs mutual data communication with the streaming server 100, displays a moving image included in content streamed by the streaming server 100 on the touch panel 240A, and outputs speech included in the content to the speaker 260A.

The third processor 290A is, for example, an arithmetic processing apparatus such as a CPU or an MPU. The third processor 290A may be implemented as a single processor or as a plurality of processors.

### 7. Operation of In-Vehicle Apparatus

Next, an operation when the in-vehicle apparatus 30 displays a captured image 20, a composite image 500, or the like on the touch panel 344 and guides the placement of the streamer terminal 200A in the vehicle 3 will be described. The composite image 500 is an image obtained by combining the guide image 345 with the captured image 20.

First, the first control section 330 of the in-vehicle apparatus 30 determines whether the vehicle 3 is in a stopped state or a parked state. The first control section 330 displays the captured image 20 captured by the streamer terminal 200A, the composite image 500, or the like on the touch panel 34, only when the vehicle 3 is in the stopped state or the parked state.

The determining of whether vehicle 3 is in the stopped state or the parked state is performed based on the vehicle speed acquired by the first control section 330 from the vehicle ECU 40, the transmission lever position information, information indicating the drive state of the drive source such as the engine of the vehicle 3, and the like. For example, the first control section 330 determines that vehicle 3 is in the stopped state or the parked state when the vehicle speed is 0 km and the transmission lever is in the park position. The first control section 330 determines that the vehicle 3 is in the parked state when the engine is in the stopped state and the transmission lever is in the park position.

The in-vehicle apparatus 30 receives the captured image 20 captured by the streamer terminal 200A connected via short-range wireless communication. The first control section 330 temporarily stores the captured image 20 received by the first short-range wireless communication I/F 32 in the first memory 340.

Upon determining that the vehicle 3 is in the stopped state or the parked state, the first control section 330 acquires the captured image 20 from the first memory 340, superimposes a guide image including guide lines on the acquired captured image 20, and generates the composite image 500. The first control section 330 displays the generated composite image 500 on the touch panel 34.

The first control section 330 selects the guide image 345 to be combined with the captured image 20, based on a capturing position selected by the streamer S operating the touch panel 34. For example, when the first capturing position is selected by the streamer S, the first guide image 345A is combined with the captured image 20 and the composite image 500 is generated. When the second capturing position is selected by the streamer S, the second guide image 345B is combined with the captured image 20 and the composite image 500 is generated. For example, when the third capturing position is selected by the streamer S, the third guide image 345C is combined with captured image 20 and the composite image 500 is generated.

The first control section 330 may select the guide image 345 to be combined with the captured image 20, based on request information received from the streaming server 100.

The viewer U that views a streaming image operates the viewer terminal 200B and transmits the request information for requesting the capturing position to the streaming server 100. The viewer U may operate the viewer terminal 200B and directly transmit the request information for requesting the capturing position to the streamer terminal 200A of the streamer S. The request information corresponds to selection information.

When a large number of viewers U are viewing the streaming image, the streaming server 100 may aggregate the number of requests per capturing position and transmit an aggregation result per capturing position to the in-vehicle apparatus 30 as the request information. Whenever receiving a request for a capturing position from the viewer terminal 200B, the streaming server 100 may transmit the request for this capturing position to the in-vehicle apparatus 30. Furthermore, the streaming server 100 may aggregate requests from the viewer U per predetermined amount of time and transmit the aggregated number of requests per capturing position to the in-vehicle apparatus 30 per predetermined amount of time.

The first control section 330 displays the request information received from the streaming server 100 on the touch panel 34. The streamer S inputs an operation for selecting the capturing position via the touch panel 34 with reference to the request information displayed on the touch panel 34. For example, the streamer S selects the capturing position with the highest number of requests and inputs the selected capturing position to the touch panel 34. The first control section 330 generates the composite image 500 obtained by combining the guide image 345 corresponding to the input capturing position with the captured image 20, and displays the generated composite image 500 on the touch panel 34.

The first control section 330 may perform image analysis on the captured image 20 of the streamer terminal 200A, detect vehicle members included in the captured image 20, and identify the capturing position of the streamer terminal 200A based on the detected vehicle members.

For example, when the capturing position is the first capturing position, the captured image 20 includes the driver seat 71, the steering wheel 72, the side-view mirror 73 at the driver seat side, the rear-view mirror 74, the A-pillar 75, the sun visor 76 at the driver seat side, and the like. Upon determining that the capturing position of the streamer terminal 200A is the first capturing position based on a detection result of these vehicle members, the first control section 330 generates the composite image 500 obtained by combining the first guide image 345A with the captured image 20 and displays the generated composite image 500 on the touch panel 34.

For example, when the capturing position is the second capturing position, the captured image 20 includes the steering wheel 72, the side-view mirror 73, the rear-view mirror 74, the A-pillar 75, the sun visor 76, and the like. Upon determining that the capturing position of the streamer terminal 200A is the second capturing position based on the detection result of these vehicle members, the first control section 330 generates the composite image 500 obtained by combining the second guide image 345B with the captured image 20 and displays the generated composite image 500 on the touch panel 34.

For example, when the capturing position is the third capturing position, the captured image 20 includes the window frame 81 at the back seat, the C-pillar 82, the back seat 83, and the like. Upon determining that the capturing position of the streamer terminal 200A is the third capturing position based on the detection result of these vehicle members, the first control section 330 generates the composite image 500 obtained by combining the third guide image 345C with the captured image 20 and displays the generated composite image 500 on the touch panel 34.

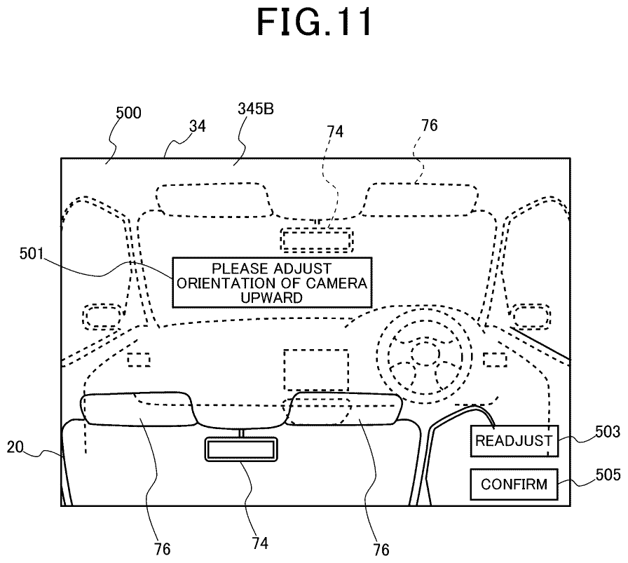

FIG. 11 is a diagram showing an example of the composite image 500 displayed on the touch panel 34 when the capturing position is the second capturing position.

The first control section 330 compares contour lines of the vehicle members included in the second guide image 345B with the vehicle members detected from the captured image 20, and displays guide information 501 for guiding a change direction of the angle of view of the streamer terminal 200A on the composite image 500 based on a comparison result. In the case of the composite image 500 shown in FIG. 11, the first control section 330 displays the guide information 501 stating “please adjust the orientation of camera 230A upward,” since a position of the rear-view mirror 74 and the sun visor 76 in captured image 20 is located below a position of the rear-view mirror 74 and the sun visor 76 in the second guide image 345B.

The composite image 500 includes a readjust button 503 and a confirm button 505. When readjusting the angle of view of the camera 230A of the streamer terminal 200A, the streamer S presses the readjust button 503 after adjusting a placement state of the streamer terminal 200A. When the readjust button 503 is pressed, the first control section 330 performs image analysis on the captured image 20 of the streamer terminal 200A and redisplays the guide information 501 based on an analysis result.

When determining that angle of view adjustment of the camera 230A of the streamer terminal 200A has ended, the streamer S presses the confirm button 505. The first control section 330 determines that the angle of view adjustment of the camera 230A has ended through the confirm button 505 being pressed, and clears display of the composite image 500.

When the confirm button 505 is pressed, the first control section 330 determines whether the position of the vehicle members in the second guide image 345B and the position of the vehicle members in the captured image 20 deviate by a predetermined distance or more. When determining that the positions of the vehicle members deviate by the predetermined distance or more, the first control section 330 may display a prompt on the touch panel 34 for inquiring whether to update the second guide image 345B. The first control section 330 extracts the contour of the object included in the captured image 20 as the second guide image 345B and generates the second guide image 345B. The first control section 330 stores the generated second guide image 345B in the first memory 340. That is, the first control section 330 changes a position of the guide lines by updating the second guide image 345B.

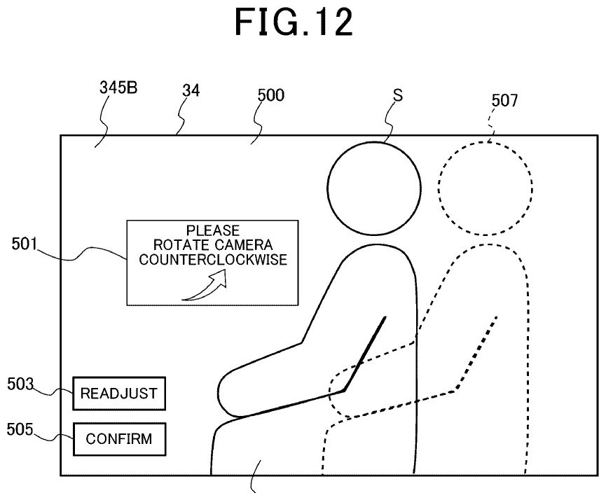

FIG. 12 is a diagram showing an example of the composite image 500 displayed on the touch panel 34 when the capturing position is the first capturing position.

The guide lines displayed in the composite image 500 may not only be guide lines indicating the contour of the vehicle members, but may also be a silhouette image indicating a contour of the streamer S captured in the captured image. The contour of the streamer S detected from the captured image 20 used during a past stream may be extracted, and a silhouette image 507 corresponding to the extracted contour may be displayed as guide lines.

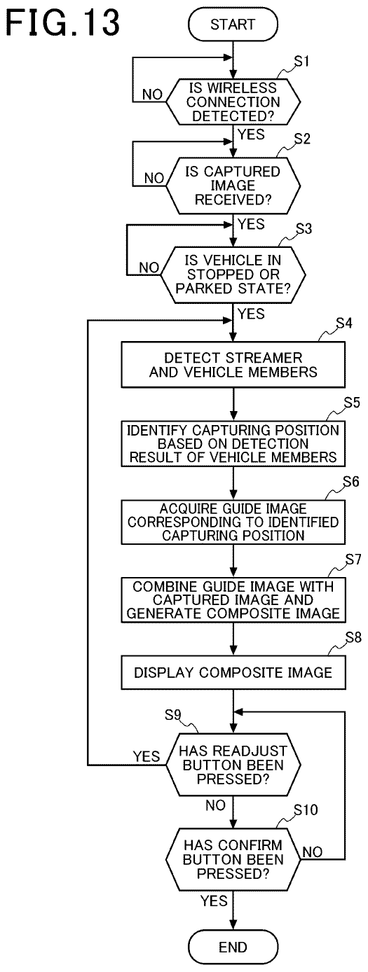

FIG. 13 is a flowchart showing an operation of the in-vehicle apparatus 30.

The operation of the in-vehicle apparatus 30 will be described with reference to the flowchart shown in FIG. 13.

First, the first control section 330 determines whether a wireless connection to the streamer terminal 200A via short-range wireless communication has been detected (step S1). The in-vehicle apparatus 30 and the streamer terminal 200A are wirelessly connected through the streamer terminal 200A approaching the vehicle 3 within a predetermined range. When a wireless connection has not been detected (NO in step S1), the first control section 330 stands by until a wireless connection is detected.

Upon detecting a wireless connection to the streamer terminal 200A via short-range wireless communication (YES in step S1), the first control section 330 determines whether the captured image 20 transmitted from the streamer terminal 200A has been received (step S2). When the captured image 20 has not been received from the streamer terminal 200A (NO in step S2), the first control section 330 stands by until the captured image 20 is received.

Upon receiving the captured image 20 from the streamer terminal 200A (YES in step S2), the first control section 330 determines whether the vehicle 3 is in the stopped state or the parked state (step S3).

The first control section 330 determines whether the vehicle 3 is in the stopped state or the parked state based on the vehicle speed acquired from the vehicle ECU 40, the transmission lever position information, the information indicating the drive state of the drive source such as the engine of the vehicle 3, and the like. When the vehicle 3 is not in the stopped state or the parked state (NO in step S3), the first control section 330 stands by until the vehicle 3 enters the stopped state or the parked state.

When the vehicle 3 is in the stopped state or the parked state (YES in step S3), the first control section 330 performs image analysis on the captured image 20 and detects the streamer S and the vehicle members (step S4). The first control section 330 identifies the capturing position of the streamer terminal 200A, based on a detection result of the streamer S and the vehicle members (step S5).

For example, when the streamer S and the steering wheel 72 are detected from the captured image 20, the first control section 330 identifies that the capturing position is the first capturing position.

When a window frame 75 of a windshield is detected from the captured image 20, the first control section 330 identifies that the capturing position is the second capturing position.

When the streamer S and the C-pillar 82 are detected from the captured image 20, the first control section 330 identifies that the capturing position is the third capturing position.

Next, the first control section 330 acquires the guide image 345 corresponding to the identified capturing position from the first memory 340 (step S6), combines the acquired guide image 345 with the captured image 20, and generates the composite image 500 (step S7).

Next, the first control section 330 displays the generated composite image 500 on the touch panel 34 (step S8). The first control section 330 stands by until an operation from the streamer S is received. First, the first control section 330 determines whether the readjust button 503 included in the composite image 500 has been pressed (step S9).

When the readjust button 503 has been pressed (YES in step S9), the first control section 330 returns to the processing of step S4 and detect the streamer S and the vehicle members from the captured image 20 of the streamer terminal 200A.

When the readjust button 503 has not been pressed (NO in step S9), the first control section 330 determines whether the confirm button 505 has been pressed (step S10). When the confirm button 505 has not been pressed (NO in step S10), the first control section 330 returns to the determining of step S9. When the confirm button 505 has been pressed (YES in step S10), the first control section 330 determines that the angle of view adjustment of the camera 230A included in the streamer terminal 200A has ended and ends this processing flow.

### 8. Variations

The above-described embodiment is a preferred embodiment of the present invention. However, the present invention is not limited to the above-described embodiment, and various modifications may be made without departing from the spirit of the present invention.

For example, the processing units in the flowchart shown in FIG. 13 are divided in accordance with their main processing content to facilitate understanding of the processing performed by the in-vehicle apparatus 30. The present invention is not limited by the manner in which the processing units in the flowchart of FIG. 13 are divided or by the names assigned to those processing units. The processing performed by the in-vehicle apparatus 30 can be divided into a greater number of processing units in accordance with the processing content, or can be divided so that one processing unit includes a greater amount of processing. The order of the processing in the above flowchart is not limited to the example shown in the figure.

In the above-described embodiment, an example has been shown in which the streamer terminal 200A is attached to the seat 10 via the attachment 50, but the placement position of the streamer terminal 200A used as the capturing apparatus may, for example, be on a center console, on a ceiling inside the vehicle (such as a position at which a lamp is provided), a headrest portion of the back seat, a rear window, or a front window.

In the above-described embodiment, a case has been described in which an inside of the vehicle 3 is captured by one streamer terminal 200A, but a plurality of streamer terminals 200A may be placed in the vehicle 3 and the inside of the vehicle 3 may be captured by this plurality of streamer terminals 200A.

In the above-described embodiment, a configuration is shown in which the streamer terminal 200A and the in-vehicle apparatus 30 are connected via short-range wireless communication and the captured image is transmitted from the streamer terminal 200A to the in-vehicle apparatus 30, but the streamer terminal 200A may upload the captured image to the streaming server 100 and the streaming server 100 may upload the captured image to the in-vehicle apparatus 30. The streamer S visually recognizes a preview image of the captured image displayed on the touch panel 34 of the in-vehicle apparatus 30 and adjusts the angle of view of the streamer terminal 200A being the capturing apparatus.

In the above-described embodiment, a case has been described in which the captured image captured by the streamer terminal 200A is transmitted to the streaming server 100 by the in-vehicle apparatus 30, but the streamer terminal 200A may transmit the captured image captured by the streamer terminal 200A to the streaming server 100.

### 9. Configurations Supported by the Above Embodiment

The above embodiment supports the following configurations.

### Configuration 1

A vehicle that uploads a captured image captured by a capturing apparatus to a streaming server as a streaming image, the vehicle including: an in-vehicle display apparatus; a communication apparatus configured to communicate with a streaming server; and a control apparatus configured to: acquire the captured image captured by the capturing apparatus retained by an in-vehicle retainer; superimpose a guide image including guide lines for guiding a capturing position of the capturing apparatus on the captured image, based on an image captured in the acquired captured image; and display the captured image on which the guide image is superimposed on the in-vehicle display apparatus.

According to the vehicle of configuration 1, the captured image is acquired from the capturing apparatus, the guide image including the guide lines for guiding the capturing position of the capturing apparatus is superimposed on the captured image based on the image captured in the acquired captured image, and the captured image on which the guide image is superimposed is displayed on the in-vehicle display apparatus. Accordingly, it is possible to adjust the capturing position of the capturing apparatus while looking at the guide lines displayed on the in-vehicle display apparatus, which facilitates angle of view adjustment of the capturing apparatus.

### Configuration 2

The vehicle according to configuration 1, further including a reception apparatus configured to accept an operation, wherein the capturing apparatus is placed in a first capturing position or a second capturing position via the in-vehicle retainer, and the control apparatus: superimposes the guide image corresponding to the first capturing position on the captured image, when selection of the first capturing position is accepted by the reception apparatus; and superimposes the guide image corresponding to the second capturing position on the captured image, when selection of the second capturing position is accepted by the reception apparatus.

According to the vehicle of configuration 2, the guide lines corresponding to the first capturing position are superimposed on the captured image and displayed, when the reception apparatus accepts selection of the first capturing position. The guide lines corresponding to the second capturing position are superimposed on the captured image and displayed, when the reception apparatus accepts selection of the second capturing position. Accordingly, it is possible to superimpose the guide image corresponding to the capturing position of the capturing apparatus on the captured image, which facilitates the angle of view adjustment even when capturing in the plurality of capturing positions with the capturing apparatus.

### Configuration 3

The vehicle according to configuration 1, wherein the capturing apparatus is placed in a first capturing position or a second capturing position via the in-vehicle retainer, and the control apparatus: receives selection information for selecting the first capturing position or the second capturing position from the streaming server; superimposes the guide image corresponding to the first capturing position on the captured image, when the first capturing position is selected using the received selection information; and superimposes the guide image corresponding to the second capturing position on the captured image, when the second capturing position is selected using the received selection information.

According to the vehicle of configuration 3, the guide image corresponding to the first capturing position is superimposed on the captured image when the first capturing position is selected using the selection information received from the streaming server, and the guide image corresponding to the second capturing position is superimposed on the captured image when the second capturing position is selected using the selection information received from the streaming server. For example, the selection information is transmitted to the vehicle through a viewer that views the streaming image registering the selection information of the first capturing position or the second capturing position with the streaming server. Accordingly, the angle of view adjustment is facilitated even when capturing in the plurality of capturing positions with the capturing apparatus, since the guide image corresponding to the capturing position of the capturing apparatus is superimposed on the captured image.

### Configuration 4

The vehicle according to configuration 3, wherein the control apparatus displays, when receiving the selection information, the first capturing position or the second capturing position indicated by the selection information on the in-vehicle display apparatus.

According to the vehicle of configuration 4, the first capturing position or the second capturing position indicated by the received selection information is displayed on the in-vehicle display apparatus, upon receiving the selection information received from the streaming server. Accordingly, it is possible to request changing the capturing position of the capturing apparatus, and for the user to recognize the requested capturing position by visually recognizing the display of the in-vehicle display apparatus.

### Configuration 5

The vehicle according to configuration 1, wherein the control apparatus: acquires vehicle information indicating whether the vehicle is in a traveling state or whether the vehicle is in a parked state or a stopped state from a vehicle control apparatus configured to control traveling of the vehicle; and superimposes the guide image on the captured image, when determining that the vehicle is in the stopped state or the parked state based on the acquired vehicle information.

According to the vehicle of configuration 5, the guide image is superimposed on the captured image and displayed, when the vehicle is in the stopped state or the parked state. It is possible to suppress having to perform the angle of view adjustment of the capturing apparatus during traveling, since the guide image is superimposed on the captured image only when the vehicle is in the stopped state or the parked state.

### Configuration 6

The vehicle according to configuration 1, wherein the capturing apparatus is placed in a first capturing position or a second capturing position via the in-vehicle retainer, and the control apparatus: classifies the captured image as any of a captured image captured in the first capturing position or a captured image captured in the second capturing position, based on an image captured in the captured image acquired from the capturing apparatus; superimposes the guide image corresponding to the first capturing position on the captured image captured in the first capturing position; and superimposes the guide image corresponding to the second capturing position on the captured image captured in the second capturing position.

According to the vehicle of configuration 6, the captured image is classified as any of the captured image captured in the first capturing position or the captured image captured in the second capturing position, based on the image captured in the captured image. The guide image corresponding to the first capturing position is superimposed when classified as the captured image captured in the first capturing position, and the guide image corresponding to the second capturing position is superimposed when classified as the captured image captured in the second capturing position. Accordingly, it is possible to superimpose the guide image corresponding to the capturing position without the user having to set the capturing position of the capturing apparatus.

### Configuration 7

The vehicle according to configuration 1, wherein the control apparatus: identifies a change direction of an angle of view of the capturing apparatus, based on an image captured in the captured image; and displays guide information for guiding the identified change direction on the in-vehicle display apparatus.

According to the vehicle of configuration 7, the change direction of the angle of view of the capturing apparatus is identified based on the image captured by the capturing apparatus, and the guide information for guiding the identified change direction is displayed on the in-vehicle display apparatus. Accordingly, it is possible for the user to adjust the angle of view of the capturing apparatus while referencing the guide information displayed on the in-vehicle display apparatus, and to facilitate the angle of view adjustment of the capturing apparatus.

### Configuration 8

The vehicle according to configuration 1, further including a reception apparatus configured to accept an operation, wherein the control apparatus: displays, on the in-vehicle display apparatus, a prompt for inquiring whether to change a position of the guide lines superimposed on the captured image when a position of a user indicated by the guide lines and a position of the user detected from the captured image deviate by a predetermined distance or more, when the reception apparatus accepts a confirm operation; and changes the position of the guide lines superimposed on the captured image, when the reception apparatus accepts an operation for changing the position of the guide lines.

According to the vehicle of configuration 8, the prompt for inquiring whether to change the position of the guide lines superimposed on the captured image is displayed on the in-vehicle display apparatus when the position of the user indicated by the guide lines and the position of the user detected from the captured image deviate by the predetermined distance or more, when the reception apparatus accepts the confirm operation. The position of the guide lines superimposed on the captured image is then changed when the reception apparatus accepts the operation for changing the position of the guide lines. Accordingly, it is possible to change the position of the guide lines superimposed on the captured image to a position preferred by the user.

### Configuration 9

A position adjustment method for causing a processor of an in-vehicle apparatus that acquires a captured image captured by a capturing apparatus and uploads the acquired captured image to a streaming server as a streaming image, to execute: acquiring the captured image captured by the capturing apparatus retained by an in-vehicle retainer; superimposing a guide image including guide lines for guiding a capturing position of the capturing apparatus on the captured image, based on an image captured in the acquired captured image; and displaying the captured image on which the guide image is superimposed on a display apparatus installed in a vehicle.

According to the position adjustment method of configuration 9, it is possible to achieve the same effects as the vehicle of configuration 1.

### Configuration 10

A non-transitory computer-readable storage medium storing a program for causing a computer of an in-vehicle apparatus that uploads a captured image captured by a capturing apparatus to a streaming server as a streaming image, to execute: processing of acquiring the captured image captured by the capturing apparatus retained by an in-vehicle retainer; processing of superimposing a guide image including guide lines for guiding a capturing position of the capturing apparatus on the captured image, based on an image captured in the acquired captured image; and processing of displaying the captured image on which the guide image is superimposed on a display apparatus installed in a vehicle.

According to the program of configuration 10, it is possible to achieve the same effects as the vehicle of configuration 1.

### REFERENCE SIGNS LIST

1 streaming system
3 vehicle
5 communication network
10 seat
11 backrest
12 headrest
13 headrest stay
20 captured image
30 in-vehicle apparatus
31 external communication interface
32 first short-range wireless communication interface
33 internal communication interface
34 touch panel
35 speech processing unit
36 speaker
40 vehicle ECU
50 attachment
51 first holder
71 seat
72 steering wheel
73 side-view mirror
74 rear-view mirror
75, 81 window frame
76 sun visor
82 C-pillar
83 back seat
100 streaming server
110 network communication I/F
130 second control section
140 second memory
141 control program
143 user information database
145 stream management database
147 content database
150 second processor
200 terminal apparatus
200A streamer terminal
200B viewer terminal
210A wireless communication I/F
220A second short-range wireless communication interface I/F
230A camera
240A touch panel
250A microphone
260A speaker
270A, 270B third control section
280A third memory
281A OS
283A APP
290A third processor
300 in-vehicle ECU
310 input/output I/F
330 first control section
340 first memory
344 touch panel
341 control program non-transitory computer-readable storage medium storing a
345 guide image
345A first guide image
345B second guide image
345C third guide image
350 first processor
500 composite image
501 guide information
503 readjust button
505 confirm button
507 silhouette image

1. A vehicle that uploads a captured image captured by a capturing apparatus to a streaming server as a streaming image, the vehicle comprising:
an in-vehicle display apparatus;
a communication apparatus configured to communicate with the streaming server; and
a control apparatus configured to:
acquire the captured image captured by the capturing apparatus retained by an in-vehicle retainer;
superimpose a guide image including guide lines for guiding a capturing position of the capturing apparatus on the captured image, based on an image captured in the acquired captured image; and
display the captured image on which the guide image is superimposed on the in-vehicle display apparatus.

2. The vehicle according to claim 1, further comprising a reception apparatus configured to accept an operation, wherein
the capturing apparatus is placed in a first capturing position or a second capturing position via the in-vehicle retainer, and
the control apparatus:
superimposes the guide image corresponding to the first capturing position on the captured image, when selection of the first capturing position is accepted by the reception apparatus; and
superimposes the guide image corresponding to the second capturing position on the captured image, when selection of the second capturing position is accepted by the reception apparatus.

3. The vehicle according to claim 1, wherein
the capturing apparatus is placed in a first capturing position or a second capturing position via the in-vehicle retainer, and
the control apparatus:
receives selection information for selecting the first capturing position or the second capturing position from the streaming server;
superimposes the guide image corresponding to the first capturing position on the captured image, when the first capturing position is selected using the received selection information; and
superimposes the guide image corresponding to the second capturing position on the captured image, when the second capturing position is selected using the received selection information.

4. The vehicle according to claim 3, wherein
the control apparatus displays, when receiving the selection information, the first capturing position or the second capturing position indicated by the selection information on the in-vehicle display apparatus.

5. The vehicle according to claim 1, wherein
the control apparatus:
acquires vehicle information indicating whether the vehicle is in a traveling state or whether the vehicle is in a parked state or a stopped state from a vehicle control apparatus configured to control traveling of the vehicle; and
superimposes the guide image on the captured image, when determining that the vehicle is in the stopped state or the parked state based on the acquired vehicle information.

6. The vehicle according to claim 1, wherein
the capturing apparatus is placed in a first capturing position or a second capturing position via the in-vehicle retainer, and
the control apparatus:
classifies the captured image as any of a captured image captured in the first capturing position or a captured image captured in the second capturing position, based on an image captured in the captured image acquired from the capturing apparatus;
superimposes the guide image corresponding to the first capturing position on the captured image captured in the first capturing position; and
superimposes the guide image corresponding to the second capturing position on the captured image captured in the second capturing position.

7. The vehicle according to claim 1, wherein
the control apparatus:
identifies a change direction of an angle of view of the capturing apparatus, based on an image captured in the captured image; and
displays guide information for guiding the identified change direction on the in-vehicle display apparatus.

8. The vehicle according to claim 1, further comprising a reception apparatus configured to accept an operation, wherein
the control apparatus:
displays, on the in-vehicle display apparatus, a prompt for inquiring whether to change a position of the guide lines superimposed on the captured image when a position of a user indicated by the guide lines and a position of the user detected from the captured image deviate by a predetermined distance or more, when the reception apparatus accepts a confirm operation; and
changes the position of the guide lines superimposed on the captured image, when the reception apparatus accepts an operation for changing the position of the guide lines.

9. A position adjustment method for causing a processor of an in-vehicle apparatus that acquires a captured image captured by a capturing apparatus and uploads the acquired captured image to a streaming server as a streaming image, to execute:
acquiring the captured image captured by the capturing apparatus retained by an in-vehicle retainer;
superimposing a guide image including guide lines for guiding a capturing position of the capturing apparatus on the captured image, based on an image captured in the acquired captured image; and
displaying the captured image on which the guide image is superimposed on a display apparatus installed in a vehicle.

10. A non-transitory computer-readable storage medium storing a program for causing a computer of an in-vehicle apparatus that uploads a captured image captured by a capturing apparatus to a streaming server as a streaming image, to execute:
processing of acquiring the captured image captured by the capturing apparatus retained by an in-vehicle retainer;
processing of superimposing a guide image including guide lines for guiding a capturing position of the capturing apparatus on the captured image, based on an image captured in the acquired captured image; and
processing of displaying the captured image on which the guide image is superimposed on a display apparatus installed in a vehicle.
